(19) United States
(12) Patent Application Publication
(10) Pub. No.: US 2016/0004271 A1
(43) Pub. Date: Jan. 7, 2016

(54) Accelerator Pedal Assembly

(71) Applicant: Raytheon BBN Technologies, Corp., Cambridge, MA (US)

(72) Inventors: Daniel Alan Gregory, Cambridge, MA (US); John-Francis Mergen, Cambridge, MA (US)

(73) Assignee: Raytheon BBN Technologies, Corp.

(21) Appl. No.: 14/321,658

(22) Filed: Jul. 1, 2014

(51) Int. Cl. G05G 1/30; B60W 20/00

(52) U.S. Cl. CPC G05G 1/30; B60W 20/10

(57) ABSTRACT

An accelerator pedal assembly is disclosed. The accelerator pedal assembly can include a pedal configured to be movable by a vehicle operator to control a speed of a vehicle. In addition, the accelerator pedal assembly can include an electromagnetic resistance mechanism coupled to the pedal. The electromagnetic resistance mechanism can be configured to provide a force to resist movement of the pedal by the operator to indicate an operational condition of the vehicle to the operator.

### BACKGROUND

Hybrid vehicles, which have internal combustion engines (e.g., gasoline and diesel engines) and electric motors, are in widespread use. Many hybrid vehicles utilize electric and internal combustion modes. For example, such hybrid vehicles are becoming increasingly sophisticated and can utilize the internal combustion engine to provide heat based on the environmental concerns of the driver and preheat the vehicle when the vehicle is plugged into a power grid to preserve battery charge in cold weather. In addition, it is common for such a hybrid vehicle to switch between electric and internal combustion modes depending on the load on the vehicle's powertrain. This switch can occur at any given point in an accelerator pedal's range of motion and can vary greatly depending on the road gradient, battery charge, temperature, current speed, etc.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a schematic illustration of a vehicle control system in accordance with an example of the present disclosure.

FIG. 2 is a schematic illustration of an accelerator pedal assembly in accordance with an example of the present disclosure.

FIG. 3 is a schematic illustration of an accelerator pedal assembly in accordance with another example of the present disclosure.

FIG. 4 is a schematic illustration of an accelerator pedal assembly in accordance with yet another example of the present disclosure.

FIGS. 5A and 5B are schematic illustrations of an accelerator pedal assembly in accordance with still another example of the present disclosure.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although the increased sophistication of the use of electric motors and internal combustion engines in hybrid vehicles provides many performance benefits, it is also very difficult, if not impossible, for a driver to anticipate the change from using an electric motor to using an internal combustion engine during operation. A driver may wish to avoid using the internal combustion engine as much as possible and may therefore wish to drive in a manner that uses the electric motor, A common practice is to “baby” the accelerator pedal to utilize the electric motor as much as possible before the internal combustion engine starts. This is done by feel as there are no feedback mechanisms to indicate an impending switch. Of course, the driver becomes aware of the switch after it has occurred by hearing the internal combustion engine start. While the hybrid vehicle's “computer” contains information regarding a changeover point in the accelerator pedal's range of motion for a given situation, the changeover point is not apparent to the driver in advance of a switch from using the electric motor to using the internal combustion engine. Thus, drivers of hybrid vehicles can benefit from knowing when their driving behavior will initiate a switch from using the electric motor to using the internal combustion engine.

Accordingly, an accelerator pedal assembly is disclosed that can provide an indication to a driver of a hybrid vehicle of a switch from using the electric motor to using the internal combustion engine. In one aspect, the accelerator pedal assembly is safe and does not interfere with operation of the vehicle. The accelerator pedal assembly can include a pedal configured to be movable by a vehicle operator to control a speed of a vehicle. Additionally, the accelerator pedal assembly can include an electromagnetic resistance mechanism coupled to the pedal. The electromagnetic resistance mechanism can be configured to provide a force to resist movement of the pedal by the operator to indicate an operational condition of the vehicle to the operator.

A vehicle control system is also disclosed. The system can include a powertrain control module to monitor and manage operation of a powertrain of a vehicle. The system can also include a feedback control module in communication with the powertrain control module to receive operational information of the vehicle. In addition, the system can include an accelerator pedal assembly having a pedal configured to be movable by a vehicle operator to control a speed of the vehicle, and an electromagnetic resistance mechanism coupled to the pedal. The feedback control module can be configured to actuate the electromagnetic resistance mechanism to provide a force to resist movement of the pedal by the operator to indicate an operational condition of the vehicle to the operator.

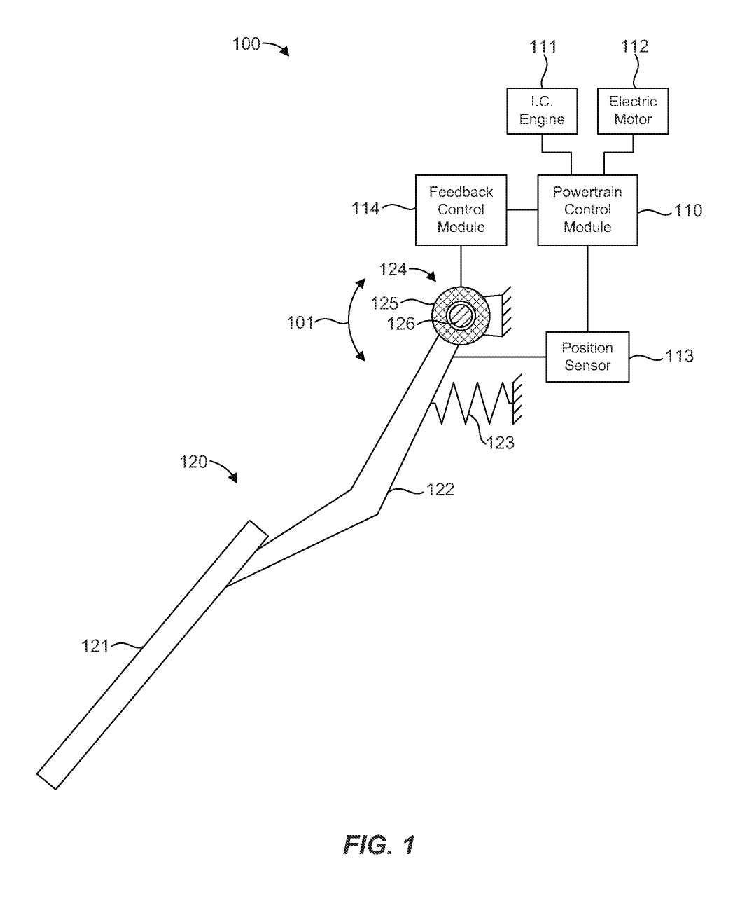

One embodiment of a vehicle control system 100 is illustrated schematically in FIG. 1. Hybrid vehicle systems can be configured for operation as a variety of different systems. For example, in a series hybrid system, an internal combustion (IC) engine can drive a generator to charge a battery for the electric motor. In a parallel hybrid system, the IC engine and the electric motor can be mechanically coupled to provide torque to the drive wheels of the vehicle. A power-split hybrid system or series-parallel hybrid system is a type of parallel hybrid system and incorporates a power-split device that allows for power paths from the engine to the wheels that can be mechanical and/or electrical. Although many variations of hybrid systems exist and are currently being developed, it should be recognized that the vehicle control system 100 can be configured for operation as any suitable type of hybrid system.

The vehicle control system 100 can comprise a powertrain control module (PCM) 110 to monitor and manage operation of a powertrain of a vehicle, which can include an IC engine 111 and an electric motor 112. The PCM 110 is typically known as a vehicle's “computer” and is also known as an electronic control unit (ECU) or engine control module (ECM), among other things. The PCM 110 is an electronic device that governs or regulates many of a vehicle's important functions, such as the fuel mixture, ignition timing, and idle speed. The PCM 110 also monitors emissions and other systems and indicates a problem by sending out a signal that activates a warning indicator, such as a light. As described herein, information from the PCM 110 can be used to provide an indication or signal to an operator of a vehicle via an accelerator control of the vehicle.

Accordingly, the vehicle control system 100 can also include an accelerator pedal assembly 120. The accelerator pedal assembly 120 can include a pedal 121 or footplate configured to be movable by a vehicle operator to control a speed of a vehicle. The accelerator pedal assembly can be configured for any suitable type of movement, such as rotational and/or translational movement. As shown in the figure, the pedal 121 can be attached to a linkage member or pedal arm 122 to facilitate movement of the pedal 121. In this case, the pedal arm 122 is pivotally mounted for rotational movement in direction 101. Such a configuration is known as a pendant-type or hanging pedal. A spring 123 can serve to bias the pedal 121 toward an initial position.

The vehicle control system 100 can also include a position sensor 113 configured to sense a position of the accelerator pedal assembly 120 as the accelerator pedal assembly moves throughout a given range of motion. In one aspect, the position sensor 113 can serve as part of an electronic throttle control (ETC) to electronically “connect” the accelerator pedal assembly 120 to a throttle valve of the I.C. engine 111, which can be actuated by an electric motor, thus substituting for a mechanical linkage between the accelerator pedal assembly 120 and the throttle valve. It should be recognized that the vehicle control system 100 can include the position sensor 113 regardless of whether the throttle valve is electronically or mechanically actuated.

The accelerator pedal assembly 120 can further include, in one example, an electromagnetic resistance mechanism 124 coupled to the pedal 121, in this case, via an association with the pivot for the pedal 121 and pedal arm 122. The electromagnetic resistance mechanism 124 can be configured to provide a force to resist movement of the pedal 121 by the operator. The electromagnetic resistance mechanism 124 can include an electrically conductive coil 125, such as copper windings, through which a current may pass. The electrically conductive coil 125 can be operable with a metallic member 126, such as iron, steel, and/or ferromagnetic material, to generate a force and/or a torque in response to current in the electrically conductive coil 125, which can act on the pedal 121 via the pedal arm 122, As shown in the figure, the electrically conductive coil 125 can be configured to be fixed relative to the vehicle, and the metallic member 126 can be configured to rotate relative to the electrically conductive coil 125. Thus, when actuated, the electromagnetic resistance mechanism 124 can generate a force and/or a torque to act on the pedal arm 122, which can be coupled to the metallic member 126. In one aspect, the metallic member 126 can comprise a metallic core configured to be disposed at least partially within the electrically conductive coil 125. Thus, for example, the electromagnetic resistance mechanism 124 can comprise a rotary solenoid.

In addition, the vehicle control system 100 can include a feedback control module 114 in communication with the PCM 110 to receive operational information of the vehicle. The feedback control module 114 can be configured to actuate the electromagnetic resistance mechanism 124, such as by providing or controlling electric current to the electrically conductive coil 125, to indicate an operational condition of the vehicle to the operator. In one aspect, the operational condition can comprise an impending transition from utilizing an electric power plant to an internal combustion power plant for propulsion of the vehicle. For example, the feedback control module 114 can receive information from the PCM 110 that indicates an imminent switch from using the electric motor to using the internal combustion engine with further movement of the accelerator pedal 121, such as when accelerating the vehicle. The feedback control module 114 can then initiate actuation of the electromagnetic resistance mechanism 124 to resist movement of the accelerator pedal 121, causing the accelerator pedal to feel “slow.” Upon feeling this resistance feedback in the accelerator pedal 121, the driver can then decide whether to cease further movement of the accelerator pedal 121, thus preventing a change from using the electric motor to using the internal combustion engine, or to continue moving the accelerator pedal, in which case the resistance provided by the electromagnetic resistance mechanism 124 can be overcome by the driver to maintain normal operation of the vehicle, wherein the vehicle switches to using the internal combustion engine. The driver can therefore be informed prior to the vehicle switching from an energy conservation mode of operation to a performance mode of operation, and can have the ability to prevent such a switch, if desired. Such feedback can improve efficiency of a hybrid vehicle by helping the driver moderate driving habits by integrating the drivers knowledge and driving experience and the vehicle's control system.

In one aspect, the force or torque provided to resist movement of the accelerator pedal 121 by the driver can be transient. For example, the feedback control module 114 can actuate the electromagnetic resistance mechanism 124 for a given time interval after which the resistance force or torque is removed. In another aspect, the force or torque provided to resist movement of the accelerator pedal 121 by the driver can be applied for a given range of motion the accelerator pedal. Thus, the driver can “push through” the resistance provided by the electromagnetic resistance mechanism 124, which may feel like a “notch” in otherwise normal movement of the accelerator pedal 121, and then a normal “feel” of the accelerator pedal 121 will resume. The resistance force or torque can be of any magnitude, last for any time duration, and be applied over any range of motion of the accelerator pedal 121. In one aspect, resistance force or torque can be applied as repeated pulses or progressively increasing and/or decreasing resistance.

In one aspect, the vehicle control system 100 can provide a safety benefit in that the maximum force or torque provided by the electromagnetic resistance mechanism 124 can be limited to a magnitude that is easily overcome by the driver of the vehicle so that the driver can push through the resistance. This ensures that should the electromagnetic resistance mechanism 124 be maintained in an “on” condition, the driver can still operate the vehicle safely and without any loss of responsiveness of the pedal 121 to driver inputs. In addition, the lack of a direct mechanical connection within the electromagnetic resistance mechanism 124 between the electrically conductive coil 125 and the metallic member 126 ensures that should the electromagnetic resistance mechanism 124 fail and be maintained in an “on” condition, the pedal 121 will function normally and will not be constrained.

It should be recognized that the vehicle control system 100 disclosed herein can be used to provide indication to the driver of a vehicle via the accelerator pedal 121 a variety of different types of operational conditions, such as vehicle conditions, driving situations or conditions, etc. In one aspect, the vehicle control system 100 can indicate to the driver that the vehicle will be reaching a specific point in its operating regime that could be of interest to the driver. For example, the vehicle control system 100 can indicate to the driver that a given speed, such as the speed limit, is about to be exceeded, that a traction or stability control function of the vehicle is about to actuate, or that the vehicle's fuel economy is about to drop below a given level. In a particular aspect, the vehicle control system 100 can indicate that further movement of the accelerator pedal 121 would cause the vehicle to enter an undesired state, which may be defined by the PCM 110 and/or the feedback control module 114. In one aspect, the driver can access a user interface to provide a definition of an undesired state to the PCM 110 and/or the feedback control module 114. In another aspect, the vehicle control system 100 can provide an alert to the driver indicating a harmful condition of the vehicle, such as low oil level, high coolant temperature, or emissions levels that indicate an engine problem. Such alerts provided by the vehicle control system 100 can be in addition to the usual warning lights or visual indicators.

As shown in FIG. 1, the electromagnetic resistance mechanism 124 can be integrated with the accelerator pedal assembly 120, such as by being integral with a joint or pivot location for the pedal arm 122. As described in more detail hereinafter, an electromagnetic resistance mechanism can be integrated with any suitable part or portion of an accelerator pedal assembly, such as being integral with a joint, roller, slider, linkage arm, etc.

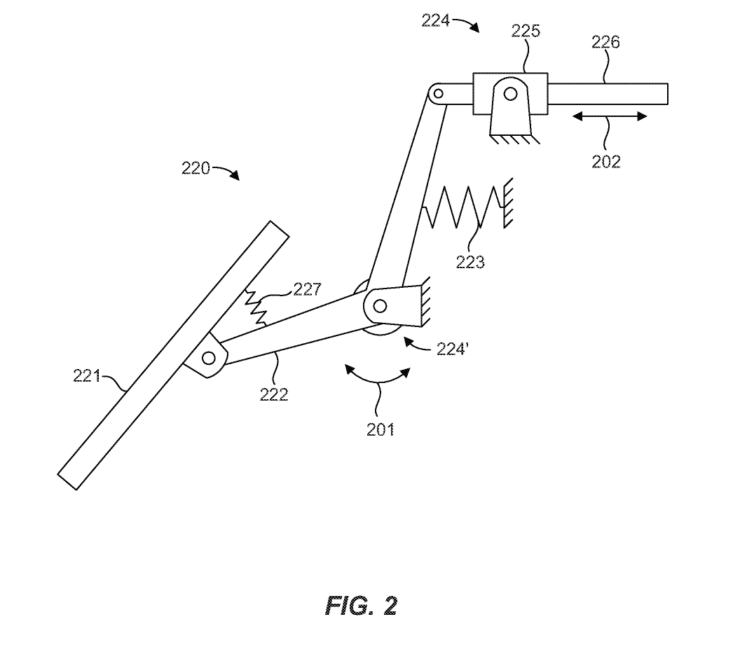

Shown in FIG. 2 is a schematic illustration of an accelerator pedal assembly 220, in accordance with another example of the present disclosure, which can be incorporated into a vehicle control system, as described herein. As with the accelerator pedal assembly 120 of FIG. 1, the accelerator pedal assembly 220 can include a pedal 221 or footplate attached to a linkage member or pedal arm 222. In this case, the pedal 221 is pivotally coupled to the pedal arm 222 and a spring 227 can serve to bias the pedal 221 toward an initial position relative to the pedal arm 222. The pedal arm 222 is pivotally mounted for rotational movement in direction 201 and a spring 223 can serve to bias the pedal 221 and pedal arm 222 toward an initial position.

An electromagnetic resistance mechanism 224 can be integrated with the accelerator pedal assembly 220 by pivotally coupling a metallic member 226 to the pedal arm 222. The metallic member 226 can be configured to translate relative to an electrically conductive coil 225 in directions 202, which can be pivotally mounted to a portion of a vehicle. In one aspect, the electromagnetic resistance mechanism 224 can comprise a linear solenoid. As with the electromagnetic resistance mechanism 124 of FIG. 1, an electromagnetic resistance mechanism 224′ can optionally be integrated with a joint or pivot location of the accelerator pedal assembly 220, as an alternative or an addition to the electromagnetic resistance mechanism 224.

It should be recognized that the metallic member 226 can serve other functions for the accelerator pedal assembly, as well, such as providing a measurement feature for determining the position of the accelerator pedal to control the speed of the vehicle, or providing a coupling location for a mechanical connection to a throttle valve.

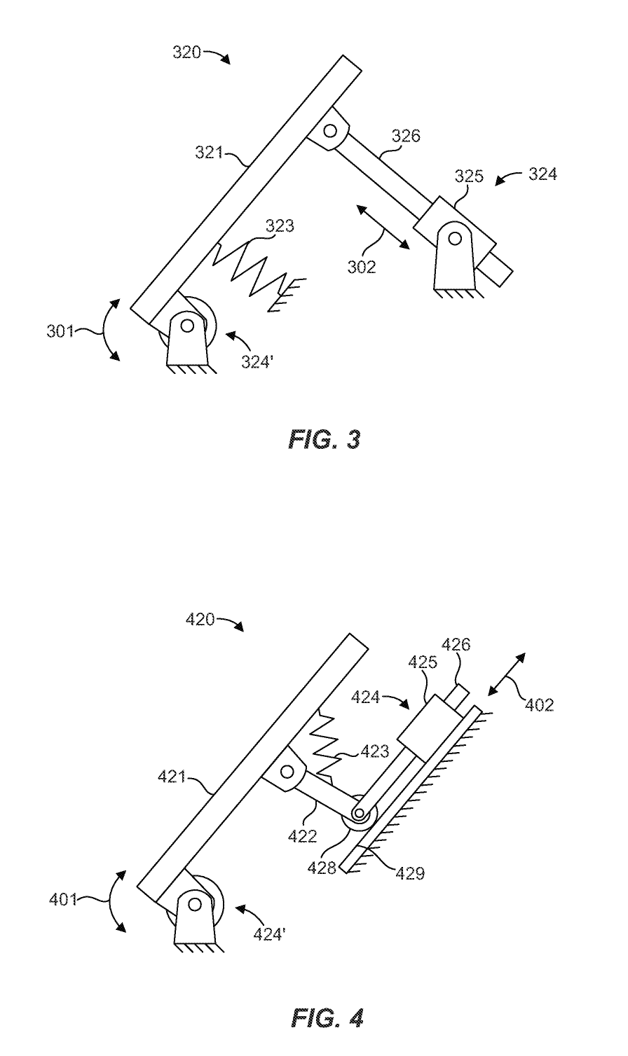

FIG. 3 is a schematic illustration of an accelerator pedal assembly 320, in accordance with yet another example of the present disclosure. In this case, a pedal 321 can be pivotally mounted to a portion of a vehicle, such as the floor, for movement in directions 301. Such a configuration is known as a floor-mounted, standing, or organ-type pedal. A spring 323 can serve to bias the pedal 321 toward an initial position.

An electromagnetic resistance mechanism 324 can be integrated with the accelerator pedal assembly 320 by pivotally coupling a metallic member 326 to the pedal 321. The metallic member 326 can be configured to translate relative to an electrically conductive coil 325 in directions 302, which can be pivotally mounted to a portion of a vehicle. An electromagnetic resistance mechanism 324′ can optionally be integrated with the pivotal mount of the accelerator pedal 321, as an alternative or an addition to the electromagnetic resistance mechanism 324.

FIG. 4 is a schematic illustration of an accelerator pedal assembly 420, in accordance with still another example of the present disclosure. As with the accelerator pedal assembly 320 of FIG. 3, the accelerator pedal assembly 420 includes a pedal 421 pivotally mounted to a portion of a vehicle, such as the floor, for movement in directions 401. In this case, however, a linkage arm 422 is pivotally coupled to the pedal 421 at one end and includes a roller 428 at an opposite end configured to roll along a surface 428 in direction 402 as the pedal rotates in direction 401. A spring 423 coupled to the pedal 421 and the linkage arm 422 can serve to bias the pedal 421 toward an initial position.

An electromagnetic resistance mechanism 424 can be integrated with the accelerator pedal assembly 420 by pivotally coupling a metallic member 426 to the linkage arm 422, such as proximate the roller 428. The metallic member 426 can be configured to translate relative to an electrically conductive coil 425 in directions 402, which can be fixedly mounted to a portion of the vehicle, such as about the surface 429. In this configuration, the metallic member 426 is subjected to purely translational movement in directions 402 due to movement of the pedal 421. An electromagnetic resistance mechanism 424′ can optionally be integrated with the pivotal mount of the accelerator pedal 421, as an alternative or an addition to the electromagnetic resistance mechanism 424.

It should be recognized that an electromagnetic resistance mechanism as disclosed herein can be integrated with any part or portion of an accelerator pedal assembly, such as being integral with any suitable joint, roller, slider, linkage arm, etc. It should also be recognized that the order or arrangement of the metallic members and the electrically conductive coils of the electromagnetic resistance mechanisms illustrated in the figures and discussed herein can be swapped with one another. Thus, for example, the coil 425 can be pivotally coupled to the linkage arm 422 and the metallic member 426 can be fixedly mounted to a portion of the vehicle, such as about the surface 429.

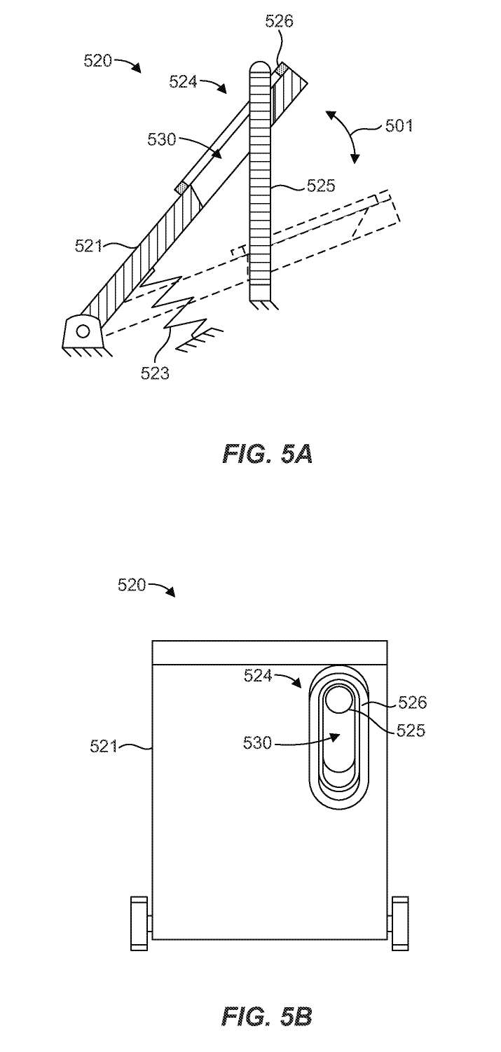

FIGS. 5A and 5B are schematic illustrations of an accelerator pedal assembly 520, in accordance with a further example of the present disclosure. As with the accelerator pedal assemblies 320, 420 of FIGS. 3 and 4, respectively, the accelerator pedal assembly 520 includes a pedal 521 pivotally mounted to a portion of a vehicle, such as the floor, for movement in direction 501. A spring 523 can serve to bias the pedal 521 toward an initial position.

An electromagnetic resistance mechanism 524 can be integrated with the accelerator pedal assembly 520 by disposing a metallic member 526 about an aperture 530 in the pedal 521. An electrically conductive coil 525 can be fixedly mounted to a portion of the vehicle, such as the floor, such that movement of the pedal 521 in direction 501 causes the metallic member 526 to translate and/or rotate relative to the electrically conductive coil 525. Thus, when an electric current is applied to the electrically conductive coil 525, a magnetic or paramagnetic attraction to the metallic member 526 can be produced, which can provide a noticeable resistance to movement of the pedal 521.

In accordance with one example of the present disclosure, a method for facilitating indication of an operational condition of a vehicle to an operator is disclosed. The method can comprise obtaining a powertrain control module to monitor and manage operation of a powertrain of a vehicle. The method can further comprise obtaining an accelerator pedal assembly having a pedal configured to be movable by a vehicle operator to control a speed of the vehicle, and an electromagnetic resistance mechanism coupled to the pedal. Additionally, the method can comprise facilitating actuation of the electromagnetic resistance mechanism to provide a force to resist movement of the pedal by the operator to indicate an operational condition of the vehicle to the operator. it is noted that no specific order is required in this method, though generally in one embodiment, these method steps can be carried out sequentially.

In one aspect of the method, facilitating actuation of the electromagnetic resistance mechanism can comprise obtaining a feedback control module and facilitating communication of the feedback control mechanism with the powertrain control module to receive operational information of the vehicle. In another aspect of the method, the electromagnetic resistance mechanism can comprise an electrically conductive coil operable with a metallic member.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. An accelerator pedal assembly, comprising:
a pedal configured to be movable by a vehicle operator to control a speed of a vehicle; and
an electromagnetic resistance mechanism coupled to the pedal and configured to provide a force to resist movement of the pedal by the operator to indicate an operational condition of the vehicle to the operator.

2. The accelerator pedal assembly of claim 1, wherein the electromagnetic resistance mechanism comprises an electrically conductive coil operable with a metallic member.

3. The accelerator pedal assembly of claim 2, wherein the electrically conductive coil is configured to pivotally couple with the vehicle and the metallic member is configured to translate relative to the electrically conductive coil.

4. The accelerator pedal assembly of claim 2, wherein the electrically conductive coil is configured to be fixed relative to the vehicle and the metallic member is configured to rotate relative to the electrically conductive coil.

5. The accelerator pedal assembly of claim 2, wherein the electrically conductive coil is configured to be fixed relative to the vehicle and the metallic member is configured to translate relative to the electrically conductive coil.

6. The accelerator pedal assembly of claim 2, wherein the metallic member comprises a metallic core configured to be disposed at least partially within the electrically conductive coil.

7. The accelerator pedal assembly of claim 2, wherein the metallic member comprises a permanent magnet.

8. The accelerator pedal assembly of claim 1, wherein the electromagnetic resistance mechanism comprises at least one of a linear solenoid and a rotary solenoid.

9. The accelerator pedal assembly of claim 1, wherein the pedal is configured for at least one of rotational and linear movement.

10. The accelerator pedal assembly of claim 1, wherein the pedal is configured as a hanging pedal.

11. The accelerator pedal assembly of claim 1, wherein the pedal is configured as a floor mounted pedal.

12. The accelerator pedal assembly of claim 1, wherein the electromagnetic resistance mechanism is associated with a pivot for the pedal.

13. The accelerator pedal assembly of claim 1, further comprising a linkage member coupled to the pedal to facilitate movement of the pedal.

14. A vehicle control system, comprising:
a powertrain control module to monitor and manage operation of a powertrain of a vehicle;
a feedback control module in communication with the powertrain control module to receive operational information of the vehicle; and
an accelerator pedal assembly having
a pedal configured to be movable by a vehicle operator to control a speed of the vehicle, and
an electromagnetic resistance mechanism coupled to the pedal,
wherein the feedback control module is configured to actuate the electromagnetic resistance mechanism to provide a force to resist movement of the pedal by the operator to indicate an operational condition of the vehicle to the operator.

15. The system of claim 14, wherein the operational condition comprises an impending transition from utilizing an electric power plant to an internal combustion power plant for propulsion of the vehicle.

16. The system of claim 14, wherein the force to resist movement of the pedal by the operator is transient.

17. The system of claim 14, wherein the force to resist movement of the pedal by the operator is configured to be overcome by the operator to maintain normal operation of the vehicle.

18. A method for facilitating indication of an operational condition of a vehicle to an operator, comprising:
obtaining a powertrain control module to monitor and manage operation of a powertrain of a vehicle;
obtaining an accelerator pedal assembly having
a pedal configured to be movable by a vehicle operator to control a speed of the vehicle, and
an electromagnetic resistance mechanism coupled to the pedal; and
facilitating actuation of the electromagnetic resistance mechanism to provide a force to resist movement of the pedal by the operator to indicate an operational condition of the vehicle to the operator.

19. The method of claim 18, wherein facilitating actuation of the electromagnetic resistance mechanism comprises obtaining a feedback control module and facilitating communication of the feedback control mechanism with the powertrain control module to receive operational information of the vehicle.

20. The method of claim 18, wherein the electromagnetic resistance mechanism comprises an electrically conductive coil operable with a metallic member.
